(19) United States
(12) Patent Application Publication
(10) Pub. No.: US 2025/0271414 A1
(43) Pub. Date: Aug. 28, 2025

(54) COMPREHENSIVE CHARACTERIZATION METHOD OF CUTTABILITY OF HYDRAULIC FRACTURING HARD ROCK

(71) Applicants: CHINA UNIVERSITY OF MINING AND TECHNOLOGY, Xuzhou (CN); Guizhou University, Guiyang (CN)

(72) Inventors: Dan MA, Xuzhou (CN); Wentao HOU, Xuzhou (CN); Qiang LI, Xuzhou (CN); Hongxiang JIANG, Xuzhou (CN); Min YU, Xuzhou (CN); Chen WANG, Guiyang (CN); Yanchuan GONG, Xuzhou (CN); Quanhui LIU, Xuzhou (CN); Di WU, Xuzhou (CN); Wei YIN, Xuzhou (CN); Shaobin HU, Xuzhou (CN); Shangbing GAO, Xuzhou (CN); Peng LI, Xuzhou (CN)

(21) Appl. No.: 18/963,954

(22) Filed: Nov. 29, 2024

(30) Foreign Application Priority Data
Feb. 28, 2024 (CN) 202410218391.8

(51) Int. Cl. G01N 33/24; G06F 30/20

(52) U.S. Cl. CPC G01N 33/24; G06F 30/20; E21B 2200/20

(57) ABSTRACT

A comprehensive characterization method of cuttability of hydraulic fracturing hard rock is provided, including the following steps: constructing a hard rock hydraulic fracturing fracture evolution model, and carrying out simulation evolution based on the hard rock hydraulic fracturing fracture evolution model to determine master control physical quantities; calculating average influence degree of the master control physical quantities on fracture density, and constructing a comprehensive characterization model of the fracture density; monitoring evolution characteristics of peak cutting force of hard rock in a simulation evolution process, and fitting a functional relationship between the peak cutting force and the fracture density; and constructing a comprehensive characterization model of the peak cutting force, and obtaining the cuttability of the hard rock through the comprehensive characterization model of the peak cutting force.

### CROSS-REFERENCE TO RELATED APPLICATIONS

This application claims priority to Chinese Patent Application No. 202410218391.8, filed on Feb. 28, 2024, the contents of which are hereby incorporated by reference.

### TECHNICAL FIELD

The disclosure relates to the technical field of hard rock mining, and in particular to a comprehensive characterization method of cuttability of hydraulic fracturing hard rock.

### BACKGROUND

For a long time, the production of hard rock mines, which is mainly based on drilling and blasting, has faced the problems of discontinuous mining and great derivative disasters. Non-explosive continuous mining is the only way for the future development of hard rock mines. At present, in order to realize rapid excavation of hard rock roadway, some scholars propose to use tunnel boring machine to excavate roadway. Based on the effective destructive effect of hydraulic fracturing technology on hard rock, in the process of hard rock roadway excavation, aided by hydraulic fracturing technology, the quality and efficiency of excavation may be improved. By drilling a hole in hard rock mass and injecting high-pressure water, after the stress around the hole reaches the crack initiation condition of the rock mass, a fracture network is formed in the hard rock mass, which destroys the integrity and strength of the hard rock mass and makes it reach the level that the roadheader may cut. For mechanized cutting hard rock, how to characterize the cutting difficulty after hydraulic fracturing of hard rock is the most important thing in mechanized application in hard rock mining field. However, at present, domestic and foreign scholars have not studied the factors affecting the cuttability of hard rock after hydraulic fracturing, and it is difficult to characterize the cuttability of hard rock. Therefore, it is necessary to study the influencing factors of cuttability characteristics of hard rock hydraulic fracturing and establish the comprehensive characterization method to promote the non-explosive mechanized mining process of hard rock mines.

### SUMMARY

The purpose of the disclosure is to solve the problem that the cuttability of hard rock is extremely complicated and difficult to characterize due to the influence of many factors, and to provide a comprehensive characterization method of the cuttability of hard rock by hydraulic fracturing, which calculates variable parameters according to different rock properties, obtains the expression of cutting index of specific rock, calculates the cutting index of rock and the hydraulic pressure value required by hydraulic fracturing, and then carries out the hydraulic fracturing process, so that a large number of cracks are generated in the hard rock, and the difficulty of cutting hard rock is reduced.

In order to achieve the above objectives, the present disclosure provides the following scheme.

The disclosure relates to a comprehensive characterization method of cuttability of hydraulic fracturing hard rock, which includes the following steps:
constructing a hard rock hydraulic fracturing fracture evolution model, and carrying out simulation evolution based on the hard rock hydraulic fracturing fracture evolution model to determine master control physical quantities;
calculating average influence degree of the master control physical quantities on fracture density, and constructing a comprehensive characterization model of the fracture density based on the average influence degree of the master control physical quantities on the fracture density;
monitoring evolution characteristics of peak cutting force of hard rock in a simulation evolution process, and fitting a functional relationship between the peak cutting force and the fracture density by combining the comprehensive characterization model of the fracture density; and
constructing a comprehensive characterization model of the peak cutting force based on the comprehensive characterization model of the fracture density and the functional relationship between the peak cutting force and the fracture density, and obtaining the cuttability of the hard rock through the comprehensive characterization model of the peak cutting force.

Optionally, carrying out the simulation evolution based on the hard rock hydraulic fracturing fracture evolution model to determine the master control physical quantities includes:
selecting physical quantities to be studied and standard conditions;
controlling variables based on the standard conditions, and performing the simulation evolution on the hard rock hydraulic fracturing fracture evolution model to obtain the functional relationship between the physical quantities to be studied and the fracture density; and
analyzing the functional relationship between the physical quantities to be studied and the fracture density to determine the master control physical quantities.

Optionally, the master control physical quantities include the Young's modulus, the shear modulus, cohesion and the water pressure.

Optionally, the average influence degree is expressed as a proportion of a certain master control physical quantity to fractures produced by all of the master control physical quantities together.

Optionally, the comprehensive characterization model of the fracture density is as follows:

$$\begin{matrix}F = {δ}_{1} P - {δ}_{2} {P}^{2} + K , \\ K = {G}_{1} \cdot {e}^{( - G / {G}_{2} )} + {C}_{1} \cdot {e}^{( - C / {C}_{2} )} - {E}_{1} \cdot {e}^{( - E / {E}_{2} )} - γ ,\end{matrix}$$

where F is fracture density after considering each of the master control physical quantities; δ₁ and δ₂ are hydraulic coefficients; P is water pressure; K is a rock fracturing parameter; G is a shear modulus; G₁ and G₂ are shear modulus coefficients; C is rock cohesion; C₁ and C₂ are cohesion coefficients; E is Young's modulus; E₁ and E₂ are Young's modulus coefficients; γ is a comprehensive characterization parameter, and e is a natural base.

Optionally, the comprehensive characterization model of the peak cutting force is as follows:

$${F}_{cutting} = {λ}_{1} + {λ}_{2} / ( 1 + {e}^{( ( {δ}_{1} P - {δ}_{2} {P}^{2} + K - {λ}_{3} ) / {λ}_{4} )} ) ,$$

where F_{cutting} is the peak cutting force, and λ₁, λ₂, λ₃ and λ₄ are cutting parameters.

Optionally, after obtaining the cuttability of the hard rock through the comprehensive characterization model of the peak cutting force, a cutting index model based on peak cutting force of mudstone is also constructed based on the comprehensive characterization model of the peak cutting force, and cutting difficulty of the hard rock is obtained through the cutting index model.

Optionally, the cutting index model is:

$$CI = {F}_{cutting} / {F}_{mudstone} ,$$

where CI is a cutting index; F_{mudstone} is peak cutting force of mudstone when the water pressure is 0 MPa.

The disclosure has the following beneficial effects.

The comprehensive characterization method of cuttability of hydraulic fracturing hard rock provided by the disclosure is beneficial to quantitatively characterize the cuttability of hydraulic fracturing hard rock; considering the water pressure and rock properties comprehensively, the functional relationship of peak cutting force-fracture density-master control physical quantity is constructed, which is effective for the application and implementation of hard rock hydraulic fracturing engineering, and fully and comprehensively uses the existing technology to establish the hard rock cuttability that is not clear before, so it is beneficial to set hydraulic fracturing process parameters for hard rock in engineering; meanwhile, the disclosure provides a calculation method of cutting index, which is more conducive to comparing the difficulty of cutting hard rock and providing method guidance for the implementation of hydraulic fracturing hard rock engineering.

### BRIEF DESCRIPTION OF THE DRAWINGS

In order to explain the embodiments of the present disclosure or the technical scheme in the prior art more clearly, the drawings needed in the embodiments will be briefly introduced below. Obviously, the drawings in the following description are only some embodiments of the present disclosure. For ordinary people in the field, other drawings may be obtained according to these drawings without paying creative labor.

FIG. 1 is a flowchart of a comprehensive characterization method of cuttability of hydraulic fracturing hard rock according to an embodiment of the present disclosure.

FIG. 2 is a fitting function diagram of fracture density-Young's modulus according to an embodiment of the present disclosure.

FIG. 3 is a fitting function diagram of fracture density-shear modulus according to an embodiment of the present disclosure.

FIG. 4 is a fitting function diagram of fracture density-rock density according to an embodiment of the present disclosure.

FIG. 5 is a fitting function diagram of fracture density-cohesion according to an embodiment of the present disclosure.

FIG. 6 is a fitting function diagram of fracture density-water pressure according to an embodiment of the present disclosure.

FIG. 7 is a fitting function diagram of fracture density-porosity according to an embodiment of the present disclosure.

FIG. 8A is Young's modulus influence degree curve according to an embodiment of the present disclosure.

FIG. 8B is shear modulus influence degree curve according to an embodiment of the present disclosure.

FIG. 8C is cohesion influence degree curve according to an embodiment of the present disclosure.

FIG. 8D is water pressure influence degree curve according to an embodiment of the present disclosure.

FIG. 9 is a fitting function diagram of peak cutting force and fracture density according to an embodiment of the present disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiments of the disclosure, but not the whole embodiments. Based on the embodiments in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and specific implementation methods.

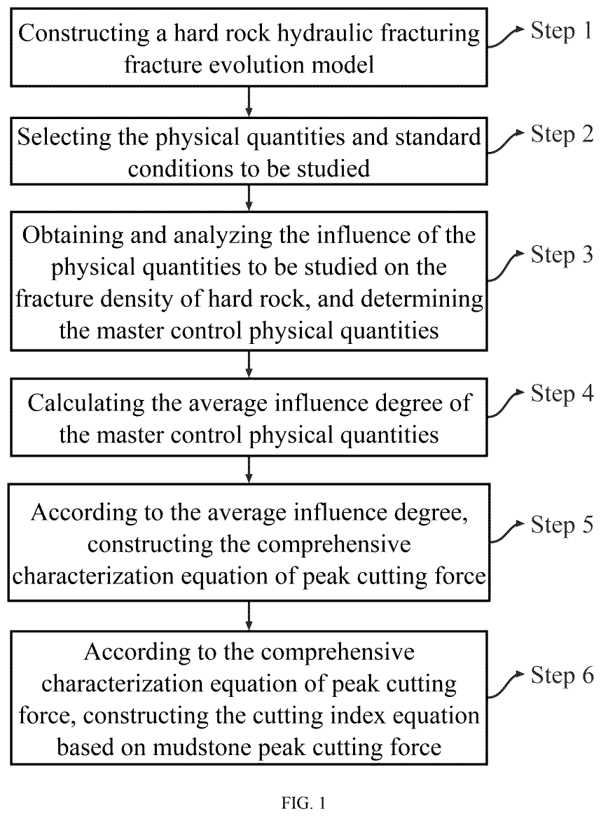

This embodiment provides a comprehensive characterization method of cuttability of hydraulic fracturing hard rock, as shown in FIG. 1, including:
step 1, constructing a hard rock hydraulic fracturing fracture evolution model, and carrying out simulation evolution based on the hard rock hydraulic fracturing fracture evolution model to determine master control physical quantities;
step 1.1, constructing a hard rock hydraulic fracturing fracture evolution model.

Firstly, the discrete element hydraulic fracturing numerical model is established, then the numerical simulation software PFC2D is applied to establish the hard rock hydraulic fracturing fracture evolution model, and the engineering geological and physical parameters are input to verify the model; after the verification is effective, monitoring points are set to monitor the number of fractures and the peak cutting force during the simulation time step. The number of fractures is used to calculate the fracture density, and the peak cutting force is used to establish the function relationship between peak cutting force and fracture density, and the time step is set to 10,000-20,000.

Step 1.2, carrying out simulation evolution based on the hard rock hydraulic fracturing fracture evolution model to determine master control physical quantities, including:
selecting physical quantities to be studied and standard conditions;
controlling variables based on the standard conditions, and performing the simulation evolution on the hard rock hydraulic fracturing fracture evolution model to obtain the functional relationship between the physical quantities to be studied and the fracture density; and
analyzing the functional relationship between the physical quantities to be studied and the fracture density to determine the master control physical quantities.

Step 1.2 of this embodiment specifically includes the following contents.

(1) Selecting physical quantities to be studied;
the physical quantities are selected in the range of water pressure and physical properties of rock mass, and mechanical parameters that may affect the cuttability of hard rock are selected. The parameters selected in this embodiment are Young's modulus, shear modulus, rock density, cohesion, water pressure and porosity, and the parameters are input into the model in turn according to the research variables, and the fracture density after the same simulation time is selected for each simulation.

(2) Selecting standard conditions;
selection of the standard conditions is beneficial to control variables. The standard conditions of this embodiment are: Young's modulus=5.0 GPa, shear modulus=8.0 GPa, density=2,500 kg/m3, cohesion=8.0 MPa, water pressure=30 MPa, and porosity=0.08.

(3) Determining the influence of the physical quantities to be studied on the fracture density of hard rock;
when the standard conditions are selected and set, the influence of a certain physical quantity on the fracture density of hard rock is studied. For example, when the influence of Young's modulus is studied, the Young's modulus in the numerical model changes, while the other standard conditions remain unchanged, such as the Young's modulus is set to 3.0 GPa-7.0 GPa, and the other physical quantities are all standard conditions, so as to control variables.

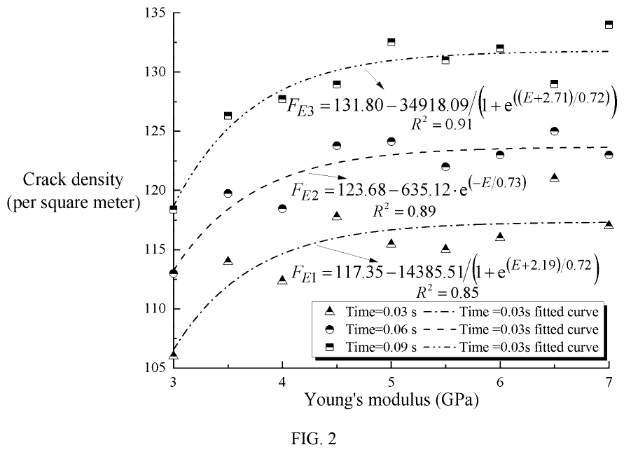

Specifically, as shown in FIG. 2, the study variable is Young's modulus, and nine groups of fracture densities of hard rock with different Young's moduli are simulated, which are 3.0 GPa, 3.5 GPa, 4.0 GPa, 4.5 GPa, 5.0 GPa, 5.5 GPa, 6.0 GPa, 6.5 GPa and 7.0 GPa respectively. The simulation time is 0.03 s, 0.06 s and 0.09 s respectively. According to the simulation results, the relationship curve between fracture density and Young's modulus is drawn and fitted.

The scatter diagram of the relationship between fracture density and a physical quantity is drawn, and the relationship is fitted, and the maximum value of fitting R² is selected, which shows that the fitting function is most in line with the mathematical relationship between fracture density and physical quantity.

Taking time=0.06 s as an example, the relationship between fracture density and Young's modulus fitting function shows that the relationship between fracture density and Young's modulus function is as follows:

$${F}_{E 2} = - 6 \; 35.12 \cdot {e}^{( - E / 0.73 )} + 123.68 ,$$

where F_{E2} is the fracture density at different Young's modulus at time=0.06 s, and E is Young's modulus.

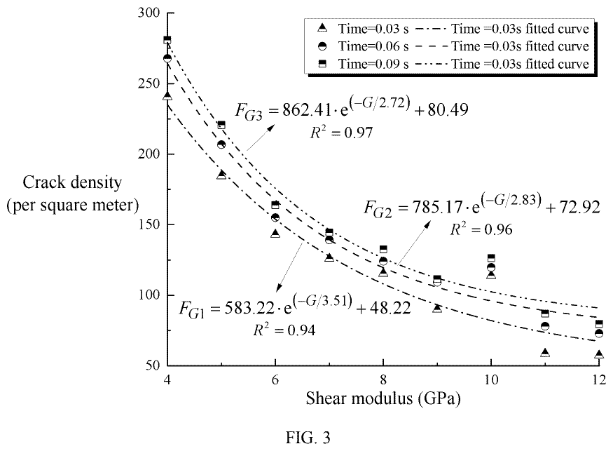

In the same way, the influence of other variables on fracture density is studied. As shown in FIG. 3, the functional relationship between fracture density and shear modulus is studied. The fitting curve shows that the functional relationship between fracture density and shear modulus is as follows:

$${F}_{G 2} = 785.17 \cdot {e}^{( - G / 2.83 )} + 72.92 ,$$

where F_{G2} is the fracture density under different shear modulus at time=0.06 s, and G is the shear modulus.

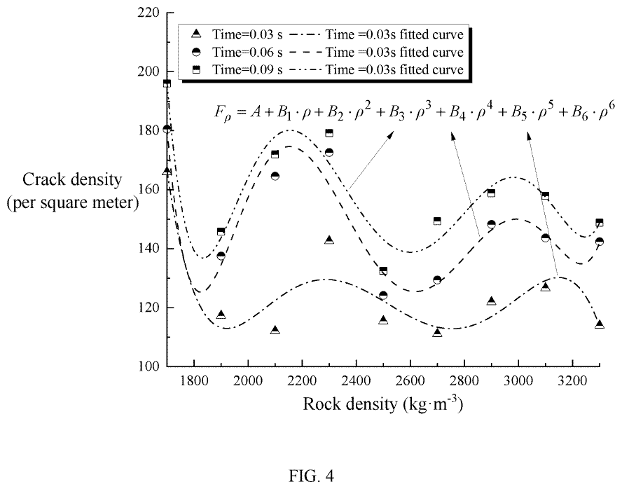

As shown in FIG. 4, the functional relationship between fracture density and rock density is studied. The fitting curve shows that the functional relationship between fracture density and rock density is:

$${F}_{ρ} = A + {B}_{1} \cdot ρ + {B}_{2} \cdot {ρ}^{2} + {B}_{3} \cdot {ρ}^{3} + {B}_{4} \cdot {ρ}^{4} + {B}_{5} \cdot {ρ}^{5} + {B}_{6} \cdot {ρ}^{6} ,$$

where F_{ρ} is the fracture density at different rock densities at time=0.06 s, A is the intercept, B₁-B₆ is the polynomial coefficient and p is the rock density.

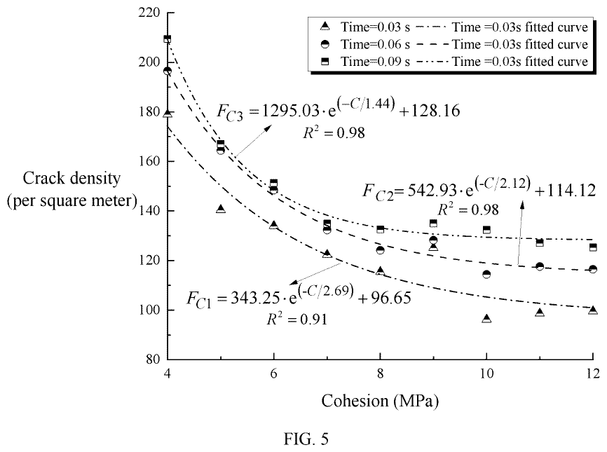

As shown in FIG. 5, the functional relationship between fracture density and cohesion is studied. The fitting curve shows that the functional relationship between fracture density and cohesion is as follows:

$${F}_{C 2} = 542.93 \cdot {e}^{( - C / 2.12 )} + 114.12 ,$$

where F_{P2} is the fracture density under different cohesion at time=0.06 s, and C is the rock cohesion.

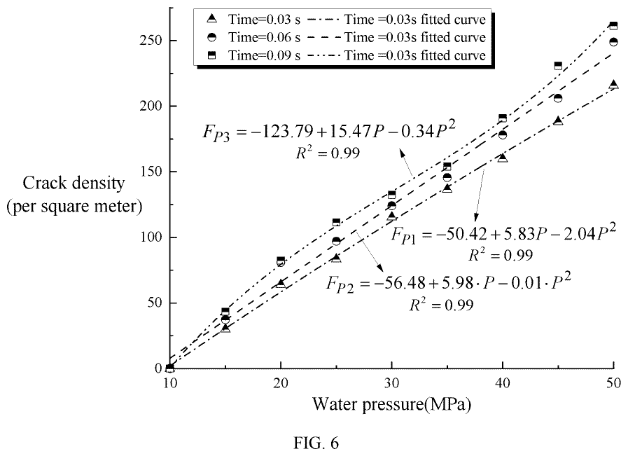

As shown in FIG. 6, the functional relationship between fracture density and water pressure is studied. The fitting curve shows that the functional relationship between fracture density and water pressure is:

$${F}_{P 2} = - 56.48 + 5.98 \cdot P - 0.01 \cdot {P}^{2} ,$$

where F_{P2} is the fracture density under different water pressures at time=0.06 s, and P is the water pressure.

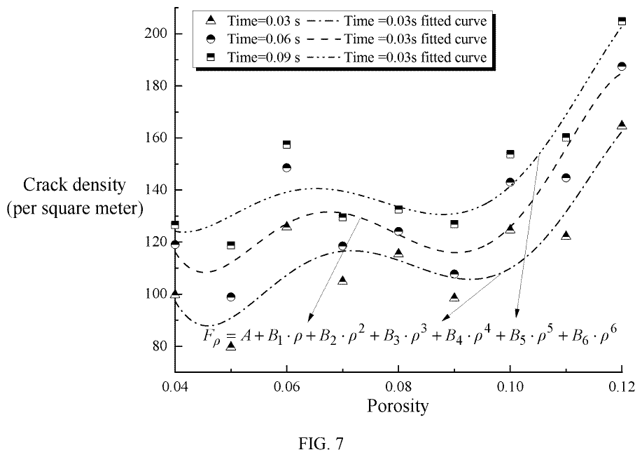

As shown in FIG. 7, the functional relationship between fracture density and porosity is studied. The fitting curve shows that the functional relationship between fracture density and porosity is:

$${F}_{ϕ} = {A}^{′} + {B}_{1}^{′} ϕ + {B}_{2}^{′} {ϕ}^{2} + {B}_{3}^{′} {ϕ}^{3} + {B}_{4}^{′} {ϕ}^{4} + {B}_{5}^{′} {ϕ}_{5} ,$$

where F_{ϕ} is the fracture density under different porosity at time=0.06 s, A′ is the intercept, B₁′-B₅′ is the polynomial coefficient, and ϕ is the rock porosity.

(4) Determining the master control physical quantities that affects the cuttability of hard rock;
according to the functional relationship between fracture density and each physical quantity to be studied, the master control physical quantities affecting the machinability of hard rock are determined. If the functional relationship is not clear, the physical quantity is not the master control physical quantity.

By analyzing the master control physical quantities that affect the cuttability of hard rock, it can be seen from FIG. 2-FIG. 7 that the fracture density does not change regularly with the change of rock density or porosity, so it is inferred that Young's modulus, shear modulus, cohesion and water pressure are the master control physical quantities that affect the cuttability of hard rock.

Step 2, calculating the average influence degree of the master control physical quantities on the fracture density;
the graph of influence degree of master control physical quantities is drawn, and the average influence degree of the master control physical quantities is calculated; the average influence degree indicates the proportion of a master control physical quantity in the joint production fracture of all master control physical quantities.

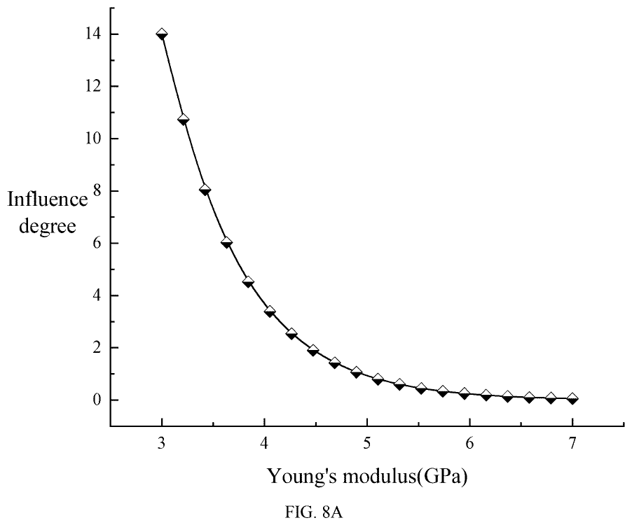

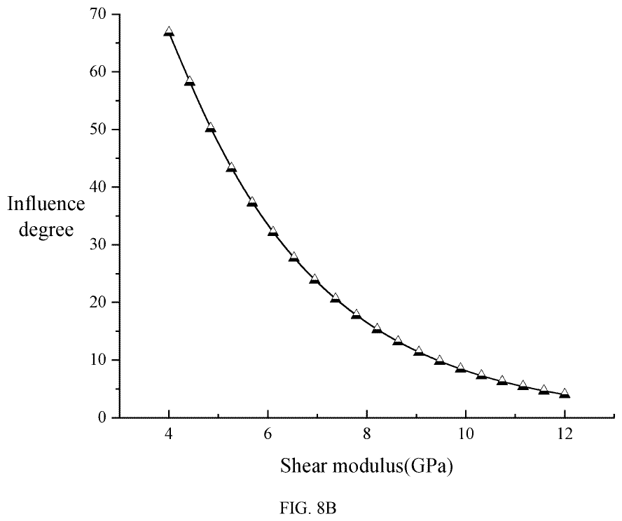

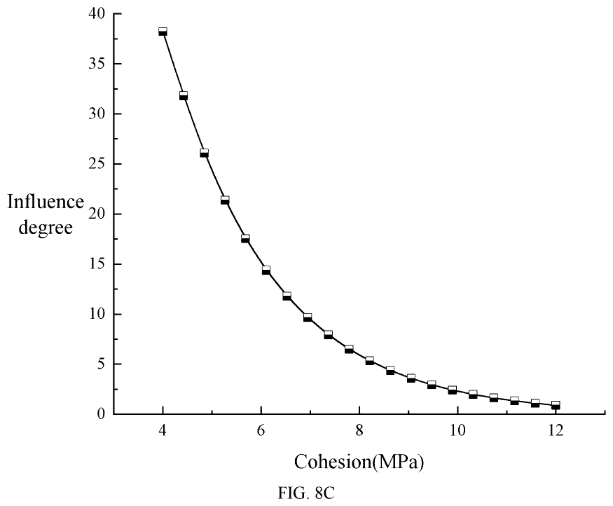

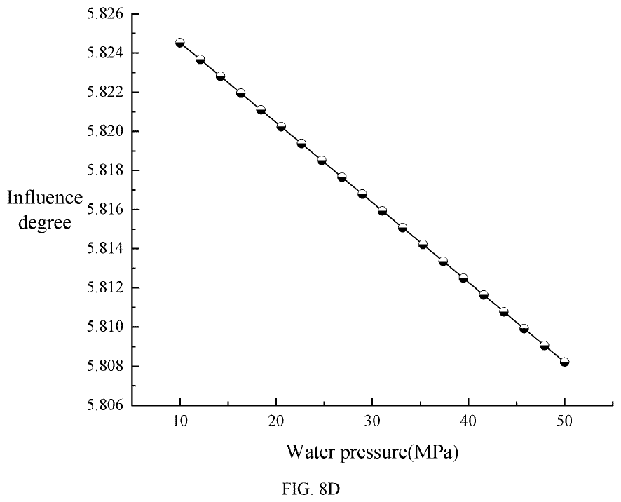

During the studies and analyzes about how the four master control factors affect the change of fracture density in hard rock, the concept of influence degree is introduced, which is the instantaneous slope of the fracture density-variable curve in FIG. 2-FIG. 7. The greater the slope, the greater the change of the fracture density when the same variable difference is changed, FIG. 8A-FIG. 8D show the relationship between the influence degree of four master control physical quantities and the master control physical quantities. FIG. 8A is the Young's modulus influence degree curve. FIG. 8B shows the shear modulus influence degree curve, FIG. 8C shows the cohesion influence degree curve, and FIG. 8D shows the water pressure influence degree curve. The influence degree of variables on fracture density is characterized by average influence degree.

The results of the standard conditions in this embodiment are as follows: the influence ratio of the four master control physical quantities on the fracture density is Young's modulus: shear modulus: cohesion: water pressure=0.06:0.55:0.25:0.14.

Step 3, constructing a comprehensive characterization model of the fracture density based on the average influence degree of the master control physical quantities on the fracture density;
according to the influence ratio of four master control physical quantities on fracture density as Young's modulus: shear modulus: cohesion: water pressure=0.06:0.55:0.25:0.14, a comprehensive expression of fracture density may be derived:

$$F = {F}_{E}^{′} + {F}_{G}^{′} + {F}_{C}^{′} + {F}_{P}^{′} ,$$

where F is the fracture density after considering each of the master control physical quantities; F_{E}′, F_{G}′, F_{C}′ and F_{P}′ are the comprehensive effects of each variable on fracture density after considering the influence degree, which may be expressed by the following formulas:
F_{E}′=0.06F_{E},
F_{G}′=0.55F_{G},
F_{C}′=0.25F_{C},
F_{P}′=0.14F_{P},

After calculation, the fracture density may be expressed by the following formula:

$$F = 431.84 \cdot {e}^{( - G / 2.83 )} + 135.73 \cdot {e}^{( - C / 2.12 )} - 38.11 \cdot {e}^{( - E / 0.73 )} + 0.84 P - 0.0014 {P}^{2} - 27.02 ,$$

For a specific rock, the initial values of Young's modulus, shear modulus and cohesion are fixed, so the above formula may be simplified as:

$$F = {δ}_{1} P - {δ}_{2} {P}^{2} + K , K = {G}_{1} \cdot {e}^{( - G / {G}_{2} )} + {C}_{1} \cdot {e}^{( - C / {C}_{2} )} - {E}_{1} \cdot {e}^{( - E / {E}_{2} )} - γ ,$$

where δ₁ and δ₂ are hydraulic coefficients; K is the rock fracturing parameter; G₁ and G₂ are shear modulus coefficients; C₁ and C₂ are cohesion coefficients; E₁ and E₂ are Young's modulus coefficients; γ is a comprehensive characterization parameter.

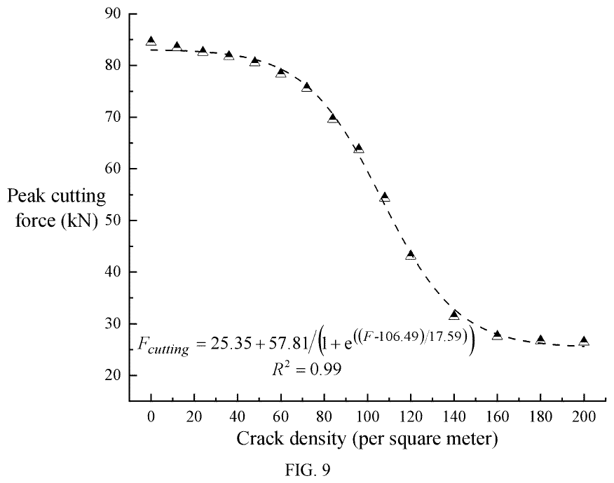

Step 4, monitoring evolution characteristics of peak cutting force of hard rock in a simulation evolution process, and obtaining the functional relationship between the peak cutting force and the fracture density by combining the comprehensive characterization model of the fracture density;
during the simulation, the evolution characteristics of peak cutting force of hard rock are monitored, and the curve of peak cutting force-fracture density is drawn as shown in FIG. 9. The fitting results show that the peak cutting force and fracture density conform to the following functional relationship:

$${F}_{cutting} = 25.35 + 57 \text{.81} / ( 1 + {e}^{( ( F - 106.49 ) / 17.59 )} ) ,$$

where F_{cutting} is the peak cutting force.

Step 5, constructing a comprehensive characterization model of the peak cutting force based on the comprehensive characterization model of the fracture density and the functional relationship between the peak cutting force and the fracture density, and obtaining the cuttability of the hard rock through the comprehensive characterization model of the peak cutting force;
combining the comprehensive expression of fracture density and the expression of peak cutting force, the comprehensive expression of peak cutting force may be obtained:

$${F}_{cutting} = {λ}_{1} + {λ}_{2} / ( 1 + {e}^{( ( {δ}_{1} P - {δ}_{2} {P}^{2} + K - {λ}_{3} ) / {λ}_{4} )} ) ,$$

where λ₁, λ₂, λ₃ and λ₄ are the cutting parameters.

Step 6, after obtaining the cuttability of the hard rock through the comprehensive characterization model of the peak cutting force, constructing a cutting index model based on peak cutting force of mudstone based on the comprehensive characterization model of the peak cutting force, and obtaining cutting difficulty of the hard rock through the cutting index model.

In order to compare the difficulty of rocks, the expression of cutting index is constructed, and mudstone is taken as the most easily cut rock in the application scope of comprehensive characterization method, and the cutting index model based on the peak cutting force of mudstone is constructed.

$$CI = {F}_{cutting} / {F}_{mudstone} ,$$

where F_{mudstone} is the peak cutting force of mudstone at water pressure=0 MPa.

According to the expression of cutting index, the difficulty of hard rock cutting is determined. If the cutting index is too high, the hydraulic pressure required for a specific cutting index may be calculated from the expression of cutting index, and then hydraulic fracturing is carried out, which may effectively reduce the difficulty of hard rock cutting.

The above-mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope defined by the claims of the disclosure.

1. A comprehensive characterization method of cuttability of hydraulic fracturing hard rock, comprising:
constructing a hard rock hydraulic fracturing fracture evolution model, and carrying out simulation evolution based on the hard rock hydraulic fracturing fracture evolution model to determine master control physical quantities;
calculating average influence degree of the master control physical quantities on fracture density, and constructing a comprehensive characterization model of the fracture density based on the average influence degree of the master control physical quantities on the fracture density;
wherein the comprehensive characterization model of the fracture density is as follows:
$$F = {δ}_{1} P - {δ}_{2} {P}^{2} + K , K = {G}_{1} \cdot {e}^{( - G / {G}_{2} )} + {C}_{1} \cdot {e}^{( - C / {C}_{2} )} - {E}_{1} \cdot {e}^{( - E / {E}_{2} )} - γ ,$$
wherein F is fracture density after considering each of the master control physical quantities; δ₁ and δ₂ are hydraulic coefficients; P is water pressure; K is a rock fracturing parameter; G is a shear modulus; G₁ and G₂ are shear modulus coefficients; C is rock cohesion; C₁ and C₂ are cohesion coefficients; E is Young's modulus; E₁ and E₂ are Young's modulus coefficients; γ is a comprehensive characterization parameter, and e is a natural base;
monitoring the number of fractures and the peak cutting force of hard rock during the simulation time steps by setting monitoring points, and fitting a functional relationship between the peak cutting force and the fracture density by combining the comprehensive expression of the fracture density and the expression of peak cutting force; and
constructing a comprehensive characterization model of the peak cutting force based on the comprehensive characterization model of the fracture density and the functional relationship between the peak cutting force and the fracture density, and obtaining the cuttability of the hard rock through the comprehensive characterization model of the peak cutting force;
the comprehensive characterization model of the peak cutting force is as follows:
$${F}_{cutting} = {λ}_{1} + {λ}_{2} / ( 1 + {e}^{( ( {δ}_{1} P - {δ}_{2} {P}^{2} + K - {λ}_{3} ) / {λ}_{4} )} ) ,$$
wherein F_{cutting} is the peak cutting force, and λ₁, λ₂, λ₃ and λ₄ are cutting parameters.

2. The comprehensive characterization method of the cuttability of the hydraulic fracturing hard rock according to claim 1, wherein carrying out the simulation evolution based on the hard rock hydraulic fracturing fracture evolution model to determine the master control physical quantities comprises:
selecting physical quantities to be studied and standard conditions;
controlling variables based on the standard conditions, and performing the simulation evolution on the hard rock hydraulic fracturing fracture evolution model to obtain the functional relationship between the physical quantities to be studied and the fracture density; and
analyzing the functional relationship between the physical quantities to be studied and the fracture density to determine the master control physical quantities.

3. The comprehensive characterization method of the cuttability of the hydraulic fracturing hard rock according to claim 1, wherein the master control physical quantities comprise the Young's modulus, the shear modulus, cohesion and the water pressure.

4. The comprehensive characterization method of the cuttability of the hydraulic fracturing hard rock according to claim 1, wherein the average influence degree is expressed as a proportion of a certain master control physical quantity to fractures produced by all of the master control physical quantities together.

5. The comprehensive characterization method of the cuttability of the hydraulic fracturing hard rock according to claim 1, wherein after obtaining the cuttability of the hard rock through the comprehensive characterization model of the peak cutting force, a cutting index model based on peak cutting force of mudstone is also constructed based on the comprehensive characterization model of the peak cutting force, and cutting difficulty of the hard rock is obtained through the cutting index model.

6. The comprehensive characterization method of the cuttability of the hydraulic fracturing hard rock according to claim 5, wherein the cutting index model is:
$$CI = {F}_{cutting} / {F}_{mudstone} ,$$
wherein CI is a cutting index; F_{mudstone} is peak cutting force of mudstone when the water pressure is 0 MPa.
